(19) United States
(12) Patent Application Publication
(10) Pub. No.: US 2012/0018026 A1
(43) Pub. Date: Jan. 26, 2012

(54) CROSS-LINKED POLYOLEFIN FOAM DUCT FOR HVAC APPLICATIONS

(75) Inventors: Bradley J. Hazen, Rochester, MI (US); Michael P. Carson, Northville, MI (US)

(73) Assignee: Unique Fabricating, Inc.

(21) Appl. No.: 12/840,566

(22) Filed: Jul. 21, 2010

(51) Int. Cl. F16L 11/04

(52) U.S. Cl. 138/137

(57) ABSTRACT

A foam air duct for transferring heated or cooled air throughout an automotive vehicle. Material for the foam air duct may be a closed-cell polyolefin foam blend that creates several advantages in automotive HVAC design including reduction in the weight of the foam air duct, flexibility, and reduction in noise, vibrations and harshness (NVH) during operation.

### TECHNICAL FIELD

The present disclosure relates to an air duct system, and more particularly to closed-cell foam ducts for use in automotive HVAC applications and a method of forming.

### BACKGROUND

Vehicles generally include an air duct system connected to an HVAC unit. The air duct system may include various types of ducts located throughout the vehicle. Such ducts include, but are not limited to, ducts positioned in the vehicle doors and those that run through the center console and circulate air to the rear of the vehicle. The design of the air ducts may vary based on the make and model of the vehicle or based on the location of the duct. Therefore, a flexible air duct capable of being formed with various components and structural designs is also needed.

The air duct system may also include one or more air ducts connected to an instrument panel positioned in the front portion of the passenger compartment. The instrument panel may include various instruments including gauges, audio equipment, and blower ports for transferring heated or cooled air from the air duct into the passenger compartment. Generally, the air duct is positioned in a confined space behind the instrument panel. Accordingly, an air duct capable of flexing during installation is needed. Further, the design of the air duct may vary based on the vehicle make and/or the vehicle model. Therefore, a flexible air duct capable of being formed with various components and structural designs is also needed.

### SUMMARY

The present application discloses an air duct comprised of a plurality of closed-cell foam sheets bonded together using heat and/or pressure. The sheets may be formed of a cross-linked polyolefin foam material including a cross-linked polyolefin foam blend comprised of polypropylene and polyethylene. The present application further discloses a method of bonding the closed-cell foam sheets to form the air duct.

### BRIEF DESCRIPTION OF THE DRAWINGS

FIG. 1 is an exemplary HVAC system;

FIG. 2 is an exemplary HVAC system;

FIG. 3 is an exemplary closed-cell foam air duct;

FIG. 4 is a method of forming an exemplary closed-cell foam air duct.

### DETAILED DESCRIPTION

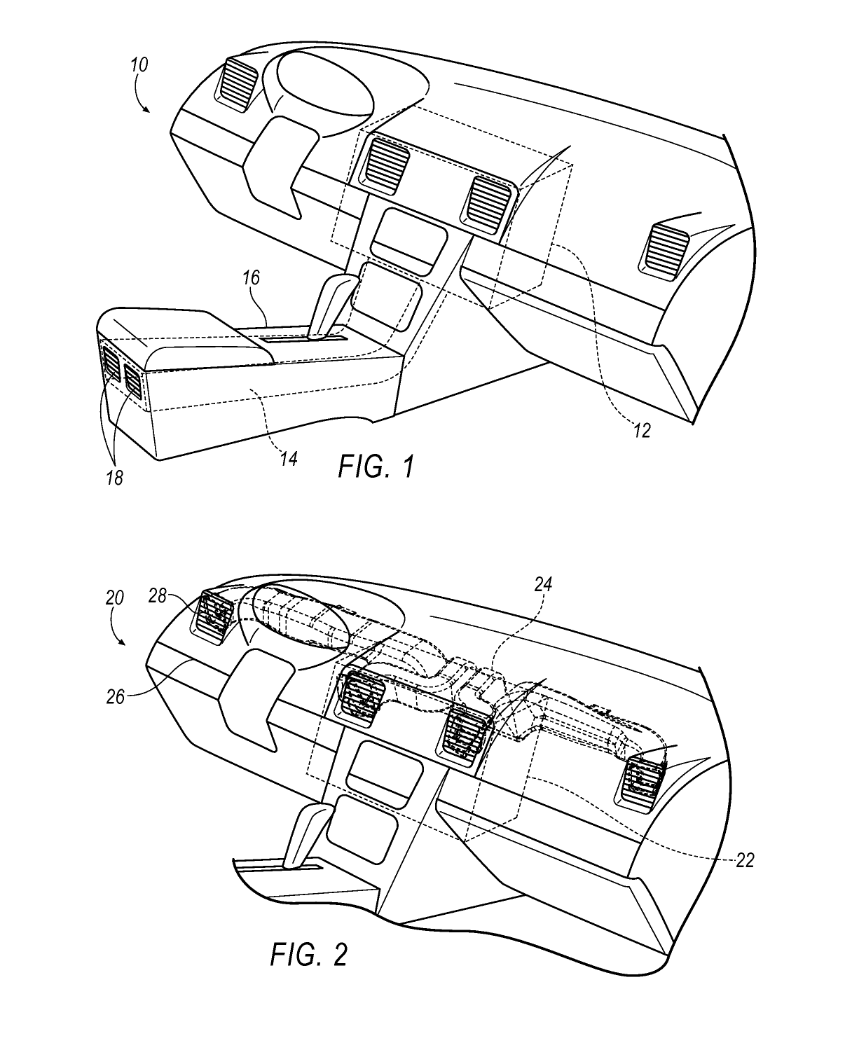

FIG. 1 illustrates an exemplary HVAC system 10. Generally, the HVAC system 10 comprises an HVAC unit 12 and at least one air duct 14. The air duct 14 may be positioned adjacent to the HVAC unit 12 using any suitable connecting mechanism. The air duct 14 may take on various forms or shapes depending on the location of the air duct 14 within the vehicle. As illustrated in FIG. 1, the air duct 14 may be configured to run through a center console 16 and may be positioned adjacent to a blower port 18. Heated or cooled air may then be passed from the HVAC unit 12 through the air duct 14 and into the rear passenger compartment of the vehicle through the blower ports 18.

FIG. 2 illustrates another exemplary HVAC system 20 comprising an HVAC unit 22 and at least one air duct 24. As illustrated in FIG. 2, the air duct 24 is positioned adjacent to the HVAC unit 22. The air duct 24 may also be positioned adjacent to an instrument panel 26 and/or blower port 28 using any suitable connecting mechanism. Heated or cooled air may then be passed from the HVAC unit 22 through the air duct 24 and into the passenger compartment of the vehicle through the blower ports 28.

Although FIGS. 1 and 2 illustrate an air duct positioned adjacent to an HVAC unit, the closed-cell foam air duct described below and the method of forming may be used to form various types of air ducts located throughout the vehicle. Accordingly, the ducts are not requires to be positioned adjacent to the HVAC unit. Instead, ducts located throughout the vehicle may be configured to interface with other air ducts in an HVAC system. Such ducts include, but are not limited to, air ducts positioned in the vehicle doors and those positioned in relation to the driver and passenger seats.

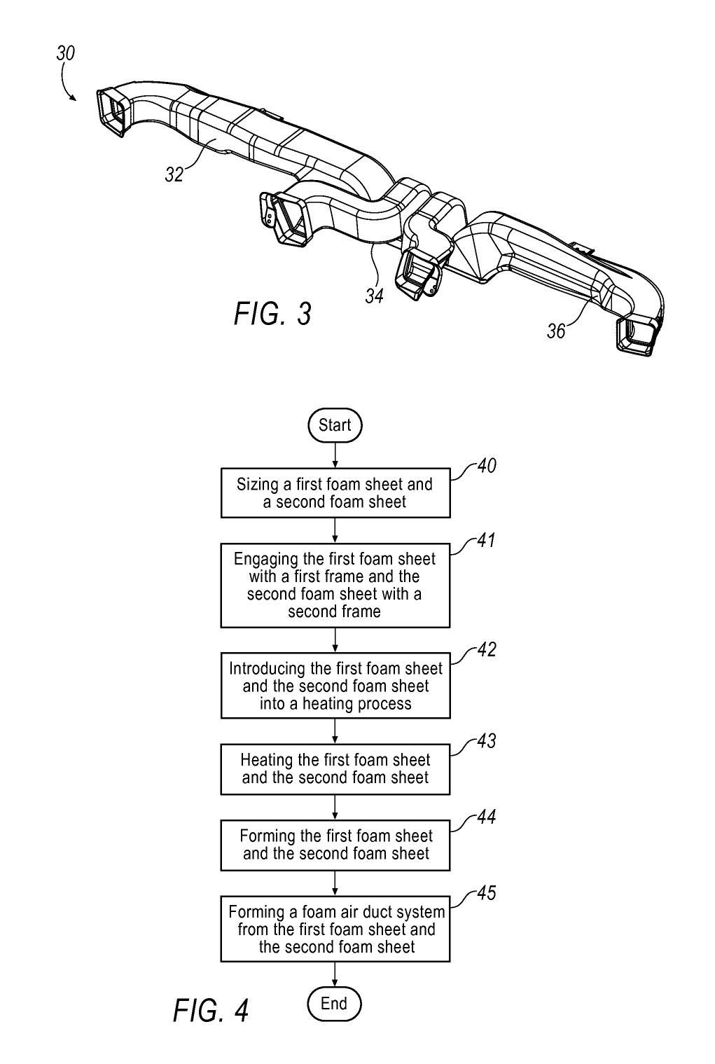

FIG. 3 illustrates an exemplary closed-cell foam air duct 30 for use in automotive HVAC systems. The closed-cell foam air duct 30 may include any combination of a left side ventilation duct 32, a center ventilation duct 34, and/or a right side ventilation duct 36, including multiple left side ventilation ducts, center ventilation ducts, and right side ventilation ducts. However, the closed-cell foam air duct 30 may also take on many different forms and include multiple and/or alternate component designs. Therefore, while an exemplary closed-cell foam air duct 30 is shown in FIG. 3, the exemplary components illustrated in the figure are not intended to be limiting. Indeed, additional or alternative components and/or implementations may be used to form various types of air ducts positioned throughout the vehicle.

The closed-cell foam air duct 30 may be formed by vacuum forming a first foam sheet and a second foam sheet in a vacuum mold under sufficient heat and pressure, discussed in more detail below. The first foam sheet and the second foam sheet may be formed of the same material. However, the first foam sheet and the second foam sheet may be formed of materials having different material properties when necessary to accommodate the design and structure needed for a particular duct design.

As a non-limiting example, the first foam sheet and the second foam sheet may be formed from a closed-cell, cross-linked polyolefin foam material. The first foam sheet and the second foam sheet may also be formed using a polyolefin foam blend comprising polypropylene and polyethylene. The percentage by weight of polypropylene and polyethylene in the polyolefin foam blend may vary as a result of the manufacturing process, but the percentage by weight of polypropylene may be higher than the percentage by weight of polyethylene. Suitable types of foam material are available through Toray Industries, Sekisui Voltek, Armacell, and Qycell Corporation. One non-limiting example may include Toray's Crosslinked Polyolefin Foam.

The first foam sheet and the second foam sheet may also have a density in the range of about 2 lb/ft³ to 4.31 lb/ft³, and more specifically, a density of about 4 lb/ft³. The first foam sheet and the second foam sheet may also have a thickness of about 4 mm. Such a design creates several advantages in air duct design including a reduction in the weight of the foam duct 30. The design also allows for easier installation of the foam duct 30. For example, the flexible foam duct 30 may be inserted and positioned behind the instrument panel or in other restricted locations with greater ease. Additionally, the use of a polyolefin foam material reduces noise, vibrations and harshness (NVH) during operation of the HVAC system 10, see FIG. 1.

FIG. 4 illustrates a method of forming a closed-cell foam air duct using a press, an upper mold tool, and a lower mold tool.

In operation, the first foam sheet and the second foam sheet are properly sized, see block 40. This may require the first foam sheet and the second foam sheet to be cut or trimmed to a specific length and/or width. The size of the first foam sheet and the second foam sheet may be determined by the size and shape of the foam air duct that will be formed. In certain applications, the size of the first foam sheet and the second foam sheet may also be determined by the size of the press and the dimensions of the upper mold tool and the lower mold tool which correspond to the design of the foam air duct being formed.

Before the foam air duct is formed, the first foam sheet is engaged with a first frame and the second foam sheet is engaged with a second frame, see block 41. The foam sheets may be engaged with the frames using hydraulically operated mechanical clamps or any other suitable means for holding the foam sheets in place during a heating operation. By clamping the foam sheets to the frames, the foam sheets are also kept in tension during the heating operation.

The first foam sheet and the first frame may be introduced into the heating operation. The process may occur in an oven or any structure capable of heating the first foam sheet to a predetermined temperature for a specific period of time. The second foam sheet and the second frame may be introduced into the heating process at the same time as the first foam sheet or in close proximity to the first foam sheet, see block 42. The second foam sheet and second frame may be introduced into the same oven or heating structure as the first foam sheet or the second foam sheet and second frame may be introduced into an alternate oven or heating structure.

The temperature and time period necessary to complete the heating process are dependent on the density and the thickness of the foam sheet being used to form the foam air duct. In one example, the first foam sheet and the second foam sheet may be heated to a temperature in the range of about 284° F. to 356° F., see block 43. More specifically, the first foam sheet and the second foam sheet may be heated to a temperature of about 300° F. When the first foam sheet and the second foam sheet are heated within this temperature range, the sheets may be molded into the shape of the desired foam air duct using the press, the upper mold tool, and the lower mold tool, discussed in further detail below.

Once heated, the first foam sheet and the second foam sheet may be formed, see block 44. The forming process may include the upper tool mold and the lower tool mold. The upper tool mold and the lower tool mold used in the forming process are selected based on the design of the air duct needed for a particular vehicle.

In one exemplary operation, the first foam sheet may be positioned adjacent to an interior surface of the upper tool mold and the second foam sheet may be positioned adjacent to an interior surface of the lower tool mold. The upper tool mold and the lower tool mold may include channels or any other suitable structures capable of removing air. Accordingly, a vacuum pump or any other suitable device may be applied to the upper tool mold causing the first foam sheet to take the form of the interior surface of the upper tool mold. This may create a first section of the foam air duct. Similarly, a vacuum pump or any other suitable device may be applied to the lower tool mold causing the second foam sheet to take the form of the interior surface of the lower tool mold. This may create a second section of the foam air duct.

The upper tool mold and the lower tool mold may then be compressed together. The effect of the heated sheets and the pressure from the compression bonds the first section of the foam air duct and the second section of the foam air duct forming a unified foam air duct, see block 45. Any existing excess material may be removed.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A closed-cell foam air duct comprising:
a first foam sheet having a density in the range of about 2 lb/ft³ to 4.31 lb/ft³; and
a second foam sheet having a density in the range of about 2 lb/ft³ to 4.31 lb/ft³, wherein the first foam sheet and the second foam sheet are bonded together using at least one of heat and pressure to form the foam duct.

2. The duct of claim 1, wherein the first foam sheet and the second foam sheet are bonded together in a twin-sheet vacuum forming process.

3. The duct of claim 1, wherein the foam comprising the first foam sheet and the foam comprising the second foam sheet is a cross-linked polyolefin foam.

4. The duct of claim 3, wherein the cross-linked polyolefin foam further comprises a blend of polypropylene and polyethylene.

5. The duct of claim 4, wherein the blend has a greater percentage by weight of polypropylene than polyethylene.

6. The duct of claim 3, wherein the cross-linked polyolefin foam has a density of about 4 lb/ft³.

7. The duct of claim 3, wherein the cross-linked polyolefin foam has a thickness of about 4 mm.

8. The duct of claim 1, wherein the closed-cell foam air duct is configured for installation in a vehicle.

9. A cross-linked polyolefin foam air duct comprising:
a first foam sheet configured to form a first section of the foam air duct, wherein the foam sheet has a density in the range of about 2 lb/ft³ to 4.31 lb/ft³; and
a second foam sheet configured to form a second section of the foam air duct, wherein the foam sheet has a density in the range of about 2 lb/ft³ to 4.31 lb/ft³,
wherein the first section and the second section are bonded together to form the foam duct.

10. The duct of claim 9, wherein the first section and the second section are bonded together in a twin-sheet vacuum forming process.

11. The duct of claim 9, wherein the cross-linked polyolefin foam further comprises a blend of polypropylene and polyethylene.

12. The duct of claim 11, wherein the blend has a greater percentage by weight of polypropylene than polyethylene.

13. The duct of claim 9, wherein the cross-linked polyolefin foam has a density of about 4 lb/ft³.

14. The duct of claim 9, wherein the cross-linked polyolefin foam has a thickness of about 4 mm.

15. The duct of claim 9, wherein the cross-linked polyolefin foam duct is configured for installation in a vehicle.

16. A closed-cell foam duct comprising:
a first cross-linked polyolefin foam sheet wherein the foam is a blend of polypropylene and polyethylene having a density in the range of about 2 lb/ft³ to 4.31 lb/ft³ and a thickness of 4 mm; and
a second cross-linked polyolefin foam sheet wherein the foam comprising the second sheet is a blend of polypropylene and polyethylene having a density in the range of about 2 lb/ft³ to 4.31 lb/ft³ and a thickness of 4 mm,
wherein the first sheet and the second sheet are bonded together using a twin-sheet vacuuming forming process to form the foam duct.

17. The duct of claim 16, wherein the foam blend comprising the first sheet and the second sheet has a greater percentage by weight of polypropylene than polyethylene.

18. The duct of claim 16, wherein the cross-linked polyolefin foam comprising the first sheet and the second sheet has a density of 4 lb/ft³.

19. The duct of claim 16, wherein cross-linked polyolefin foam duct is configured for installation in a vehicle.
